(19) United States
(12) Patent Application Publication
(10) Pub. No.: US 2011/0207013 A1
(43) Pub. Date: Aug. 25, 2011

(54) MULTIPLE FLOW STREAM SENSOR

(75) Inventor: Aaron Crumm, Ann Arbor, MI (US)

(73) Assignee: ADAPTIVE MATERIALS, INC., Ann Arbor, MI (US)

(21) Appl. No.: 13/031,449

(22) Filed: Feb. 21, 2011

Related U.S. Application Data
(60) Provisional application No. 61/306,525, filed on Feb. 21, 2010.

(51) Int. Cl. H01M 8/04; H01M 8/24

(52) U.S. Cl. 429/457

(57) ABSTRACT

A solid oxide fuel cell system (10) includes an air/fuel handling plate (16) at least partially defining an anode air chamber (34), a cathode air chamber (32), and a fuel flow path (68). The air/fuel handling plate (16) includes a converging region where the anode air chamber (34), cathode air chamber (32), and fuel flow path (68) are arranged in generally parallel, side-by-side relationship. A multi-stream flow sensor (66) is coupled to the air/fuel handling plate (16), and disposed in the converging region where it simultaneously senses the mass flow rates of the air and fuel in each of anode air chamber (34), cathode air chamber (32) and fuel flow path (68). The multi-stream flow sensor (66) includes an anode air flow sensing unit (74), a fuel flow sensing unit (76), and a cathode air flow sensing unit (78). Each sensing unit (74, 76, 78) includes a heated thin film anemometer sensing membrane (74A, 76A, 78A) and a paired reference element (74B, 76B, 78B). The sensing membranes (74A, 76A, 78A) and corresponding reference elements (74B, 76B, 78B) are all disposed parallel to one another in the respective streams of flow.

### CROSS REFERENCE TO RELATED APPLICATIONS

This application claims priority to Provisional Patent Application No. 61/306,525 filed Feb. 21, 2010, the entire disclosure of which is hereby incorporated by reference and relied upon.

### GOVERNMENT INTERESTS

None.

### BACKGROUND OF THE INVENTION

1. Field of the Invention

This invention relates generally to fuel cell systems, and more specifically to the management of multiple gas flow streams entering a solid oxide fuel cell system.

2. Related Art

Fuel cells can generate electricity be reacting a fuel (hydrogen, hydrocarbon) and an oxidant on opposite electrodes of an electrochemical cell. Portable fuel cell systems can operate utilizing a raw fuel contained onboard. Raw fuel requires further processing prior to utilization by the electrochemical cell. Raw fuel can be refined through a process that includes filtering the raw fuel through a filter and reforming the raw fuel by reacting the raw fuel with an oxidant at an onboard reformer to partially oxidize the fuel. Once the raw fuel is processed, the fuel is suitable for use in a fuel cell system, that is, as a fuel that can be utilized by the electrochemical cell.

The process of transforming raw fuel into a fuel suitable for use in a fuel cell requires several large, heavy and costly components, including pumps, blowers, fans, filters, reformers, and sensors, each of which contribute significantly to the volume, weight, and overall cost of a fuel cell system. Included among these are components that deliver and control air flow to the anode and to the cathode of the fuel cell. The anode air flow stream is supplied to the onboard reformer and the anode air flow stream flow rate is manipulated to control an air-to-fuel ratio to reform fuel by partial oxidation. To achieve the desired air-to-fuel ratio, most fuel cell systems include anode air processing components such as an air filter, controllable actuators, feedback control sensors, and various air delivery components. Similarly, fuel cell systems often also include fuel processing components such as a fuel filter, controllable actuators, feedback control sensors, regulators, heating elements and expansion chambers. These fuel delivery components are used to deliver fuel to proper locations within the fuel cell system where the fuel can mix with the anode air flow stream prior to delivery to the onboard reformer. Typical fuel cell systems further include components to direct reformed fuel from the onboard reformer to the fuel cell anode, thereby providing fuel for electrochemical fuel cell reactions.

Reducing the volume, weight, and/or cost of a fuel cell system are goals shared by many in the fuel cell industry, as well as the desire to create more efficient fuel cell systems. Therefore, there is a need for robust fuel cell systems with onboard reforming that is easy to manufacture, low cost, and that a have high power to volume ratio and a high power to weight ratio.

### SUMMARY OF THE INVENTION

According to one aspect of this invention, a fuel cell system includes a fuel cell stack configured to generate electricity by reacting oxygen and a gaseous fuel. The fuel cell stack includes an anode portion and a cathode portion. An air/fuel handling plate at least partially defines an anode air chamber, a cathode air chamber, and a fuel flow path. The anode air chamber is configured to route air to the anode portion of the fuel cell stack. The cathode air chamber is configured to route air to the cathode portion of the fuel cell stack. The fuel flow path is configured to route gaseous fuel to the anode portion of the fuel cell. A unitary, multi-stream flow sensor is coupled to the air/fuel handling plate. The multi-stream flow sensor has an anode air flow sensing unit operatively disposed in the anode air chamber, a fuel flow sensing unit operatively disposed in the fuel flow path, and a cathode air flow sensing unit operatively disposed in the cathode air chamber.

The multi-stream flow sensor may be used to determine the flow rate of air passing through the cathode air chamber simultaneously with the flow rate of air passing through the anode air chamber and the flow rate of fuel passing through the fuel path so that appropriate control strategies can be implements to make the fuel cell operate with maximum efficiency. For example, the flow rates of any one (or more) of the three gaseous flows can be manipulated to improve operating efficiency or achieve other desirable operating characteristics of the system. Utilizing a single, multi-stream flow sensor at a strategic location in the air/fuel handling plate provides significant cost reduction advantages compared to traditional systems utilizing several independent flow sensors each with separate mounting requires and electrical connection demands.

According to another aspect of this invention, an air/fuel handling plate is provided for a fuel cell system. The air/fuel handling plate includes an anode air chamber, a cathode air chamber, and a fuel flow path. The anode air chamber is configured to route air to the anode portion of a fuel cell stack. The cathode air chamber is configured to route air to the cathode portion of a fuel cell stack. And the fuel flow path is configured to route gaseous fuel to the anode portion of a fuel cell. A unitary, multi-stream flow sensor is coupled to the air/fuel handling plate. The multi-stream flow sensor has at least two sensing units operatively disposed, one each, in the anode air chamber, the fuel flow path, and/or the cathode air chamber.

According to a still further aspect of this invention, a method is contemplated for routing air and fuel gases to a solid oxide fuel cell system. The method comprises the steps of: providing a fuel cell stack configured to generate electricity by reacting oxygen and a gaseous fuel, the fuel cell having an anode portion and a cathode portion; routing air to the anode portion of the fuel cell stack through an anode air chamber; routing air to the cathode portion of the fuel cell stack through a cathode air chamber; routing gaseous fuel to the anode portion of the fuel cell stack through a fuel flow path; the routing step including converging the respective flows of cathode air, anode air and fuel in generally parallel, side-by-side flow paths; and simultaneously sensing the mass flow rates of the air and fuel in each of the anode air chamber, cathode air chamber and fuel flow path with a multi-stream flow sensor disposed in the converging region.

### BRIEF DESCRIPTION OF THE DRAWINGS

These and other features and advantages of the present invention will become more readily appreciated when considered in connection with the following detailed description and appended drawings, wherein:

FIG. 1 is perspective view of a fuel cell system in accordance with an exemplary embodiment of the present disclosure;

FIG. 2 is another perspective view of a fuel cell system as in FIG. 1;

FIG. 3 is a perspective view of an integrated air/fuel handling plate of the fuel cell system shown in FIG. 1;

FIG. 4 is an exploded view of the fuel cell system of FIG. 1 showing the fuel cell stack in cross-section;

FIG. 5 is a top view of the air/fuel handling plate indicating placement of a multiple flow stream flow sensor according to one embodiment of this invention;

FIG. 6 is a schematic view of an electric circuit for the multiple flow stream flow sensor;

FIG. 7 is a simplified elevation view of the multiple flow stream flow sensor; and

FIG. 8 is a fragmentary cross section of the integrated air/fuel handling plate showing the multiple flow stream flow sensor exploded therefrom.

### DETAILED DESCRIPTION OF THE PREFERRED EMBODIMENT

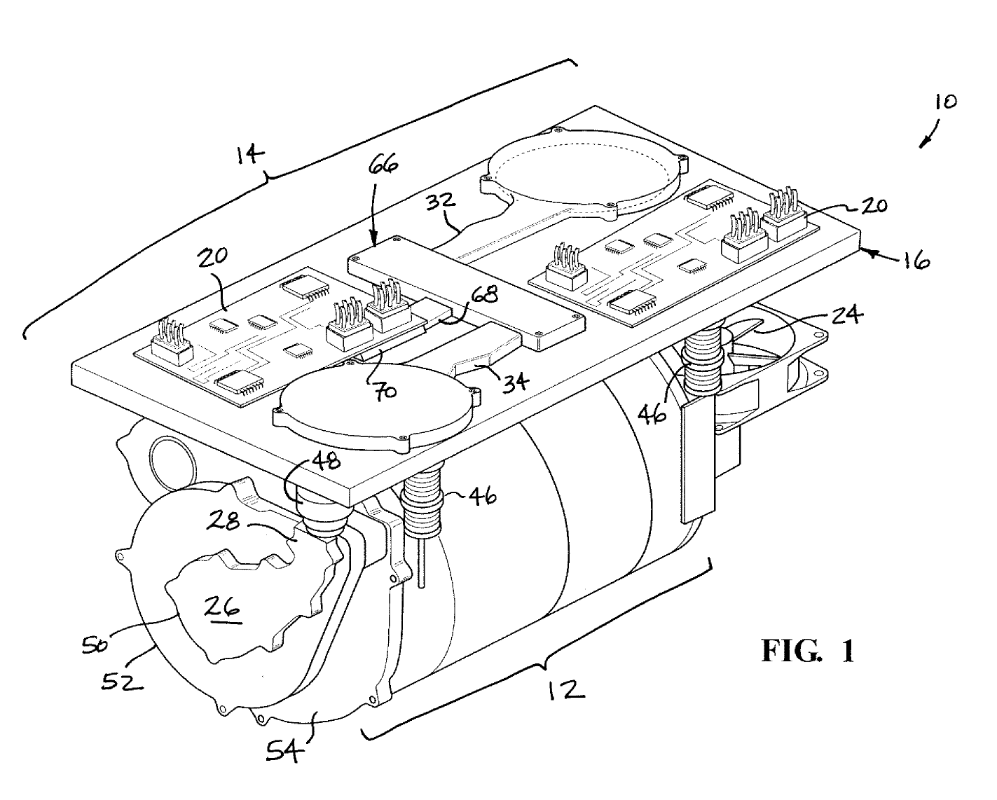

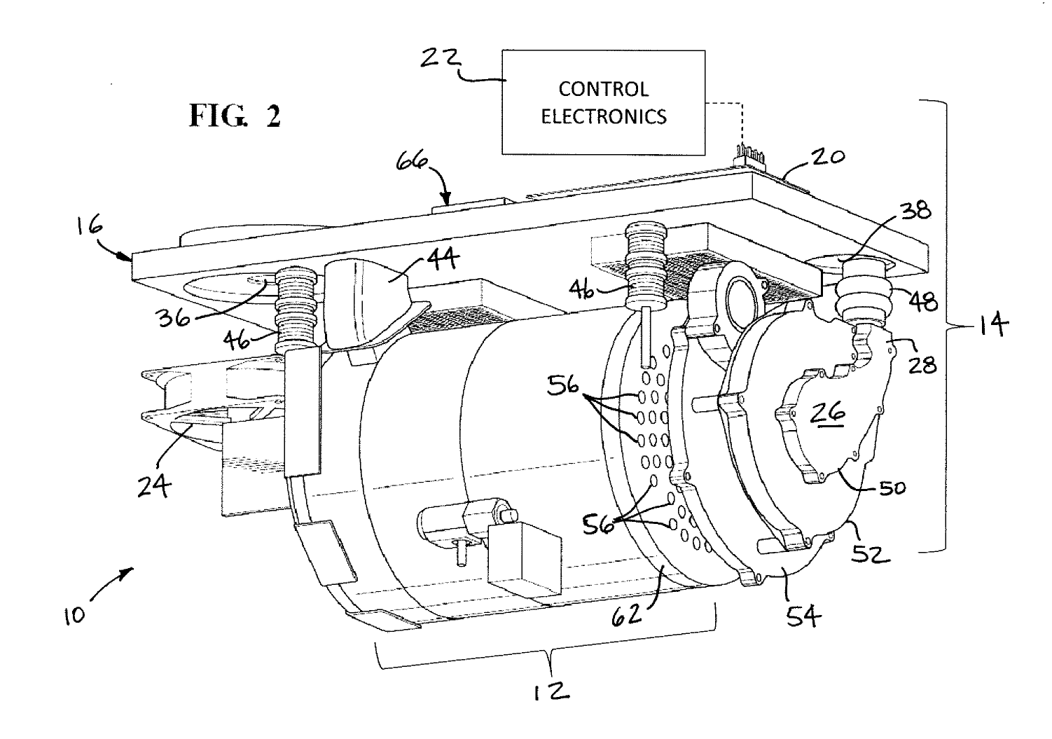

Referring to the figures wherein like numerals indicate like or corresponding parts throughout the several views, an exemplary fuel cell system is generally shown at 10 in FIGS. 1-3. The fuel cell system 10 includes a fuel cell stack 12 and a balance of plant subsystem 14. The fuel cell stack 12 comprises the power generating component of the fuel cell system 10. The balance of plant subsystem 14 includes fuel and air management components of the fuel cell system 10, which deliver fuel and air to desired locations of the fuel cell stack 12. Preferably, the fuel is a light hydrocarbon, such as methane, propane or butane, however, heavier hydrocarbons can also be used under appropriate conditions. The balance of plant subsystem 14 may also be designed to remove exhaust fluid from the fuel cell stack 12.

The balance of plant subsystem 14 includes an integrated air/fuel handling plate, generally indicated at 16, a rechargeable battery (not shown), a power electronics system 20, an exhaust blower 24, anode air/fuel delivery system 28, a user interface (not shown), heat management systems, environmentally sealed air, power and lines with wall pass-through openings (not shown). The rechargeable battery 18 can be any battery suitable for hybridization with the fuel cell stack 12 through the power electronics system 20. The rechargeable battery 18 can comprise any of several rechargeable battery technologies including, for example, nickel-cadmium, nickel-metal hydride, lithium-ion, and lithium-sulfur technologies, as well as suitable battery technologies that may be developed in the future. In alternative embodiments, other reversible energy storage technologies such as ultra-capacitors can be utilized in addition to or instead of the rechargeable battery 18. Further in alternate embodiments, multiple energy storage devices can be utilized within a fuel cell system 10.

The power electronics system 20 may include an electrically conductive network configured to route power between the fuel cell stack 12 and the battery 18, and also from the energy conversion devices (fuel cell stack 12 and the battery 18) to a user interface panel (not shown). Power levels within the power system 20 can be controlled utilizing power conversion members (not shown) controlled by a suitable control system 22.

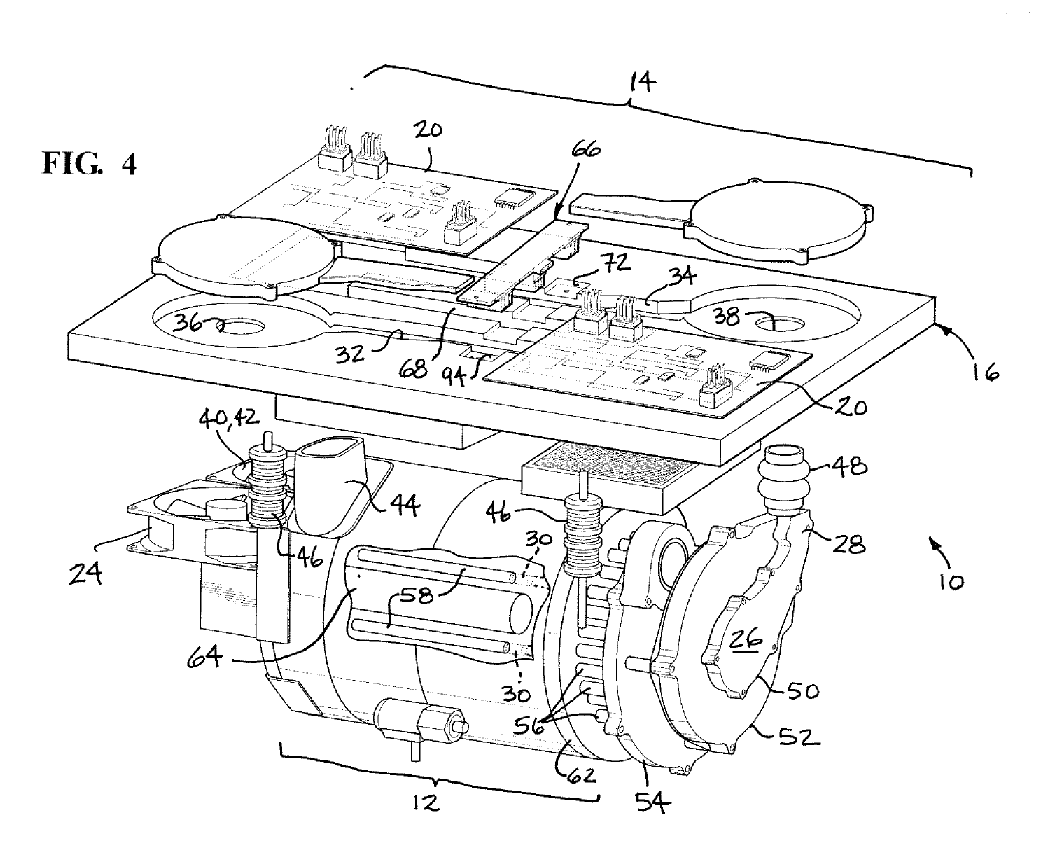

The exhaust blower 24 is configured to drive exhaust gases away from the fuel cell stack 12 in an exhaust flow path direction. In an exemplary embodiment, the exhaust blower 24 is configured to draw heat away from the integrated air/fuel handling plate 16. In an alternate embodiment, the integrated air/fuel handling plate 16 is positioned to intersect the exhaust flow path substantially perpendicular to the exhaust flow path direction such that the exhaust gases provide preheating to air within the integrated air/fuel handling plate 16. An anode air blower 26 is configured to motivate anode air at controlled flow rates to the fuel cell stack 12. The anode air blower 26 is part of an anode air/fuel delivery system 28 that also includes a fuel valve and an air fuel mixing point. The fuel valve may be incorporated into the air/fuel handling plate 16. Fuel is delivered at controlled flow rates to the anode air/fuel delivery system 28 and is mixed with controlled amounts of air such that desired amounts of fuel along with a desired ratio of air to fuel is delivered to onboard reformers 30 (FIG. 4) of the fuel cell stack 12. The fuel level is controlled utilizing a fuel flow sensor and feedback control to actuate a fuel valve (not shown) to desired positions. Although the exemplary balance subsystem 14 is described having various exemplary actuators for motivating gases throughout the fuel cell system 10, it is to be understood that other types of actuators (for example, pumps, fans, and blowers) can be utilized to motivate the gasses.

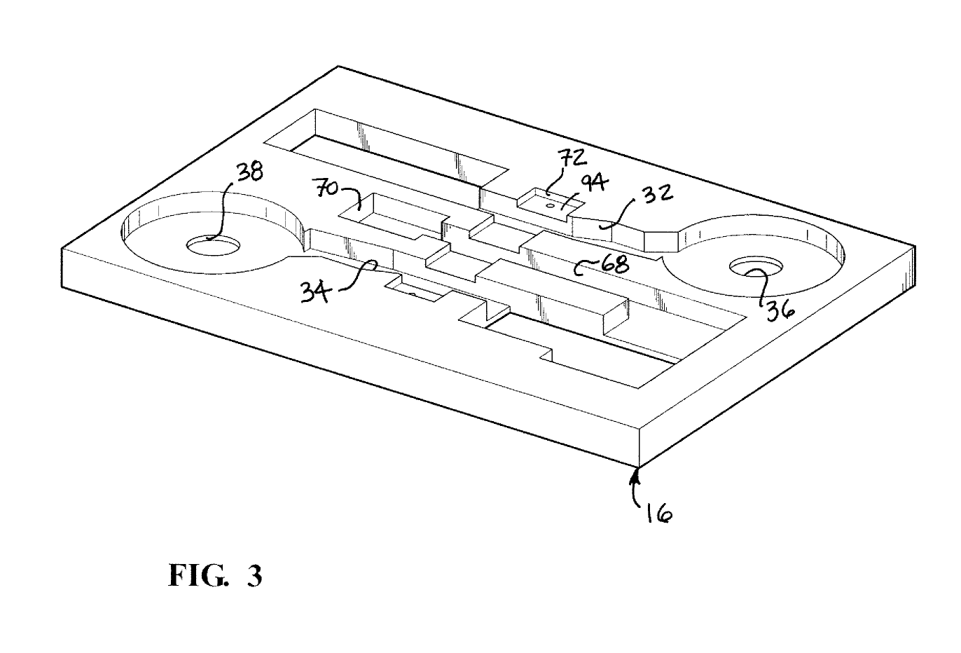

Referring to FIG. 3, the integrated air/fuel handling plate 16 includes formations that define fluid flow channels. These channels include a cathode air chamber 32 and an anode air chamber 34. A cathode blower opening 36 is formed in the cathode air chamber 32, and an anode blower opening 38 is formed in the anode air chamber 34. In addition, the cathode and anode air chambers 32, 34 may also include respective filters, reservoirs and other features including, but not limited to, those described in US Patent Publication No. US 2010/0310948, published Dec. 9, 2010, the entire disclosure of which is hereby incorporated by reference and relied upon. During operation air enters an outer housing (not shown) of the fuel cell system 10 into a housing chamber. Incoming air then travels through anode and cathode air filters, and then is routed into the respective anode air chamber 34 and cathode air chamber 32.

FIG. 4 shows an exploded view of the air/fuel handling plate 16 including a cathode blower assembly 40. The cathode air blower assembly 40 includes a blower housing (not shown), a cathode air blower impeller 42 powered by an electric motor (not shown). The cathode air blower impeller 42 is mounted on the underside of the air/fuel handling plate 16 below the cathode blower opening 36. The cathode air blower assembly 40 motivates the cathode air from the cathode chamber 32 through a resilient boot member 44 (FIG. 4) to the fuel cell stack 12. The integration of the cathode air blower assembly 40 within the integrated air/fuel handling plate 16 provides weight and size advantages when compared with non-integrated designs. Further, the integration of the cathode blower assembly 40 provides high mechanical strengths and high resistance to vibration and the ability to integrate active cooling to electrical components, to seal components and to integrate active cooling of electrical components.

The air/fuel handling plate 16 may include a sandwich of upper and/or lower plates or covers, as needed, that are fastened together with suitable gaskets or seals to enclose the anode air chamber 34 and cathode air chamber 32 into air-handling plenums. Portions of the power electronics system 20 are mounted to the air/fuel handling plate 16 proximate the anode chamber 34 and the cathode chamber 32. By mounting the power electronics 20 proximate the air flow passageways, heat can be transferred away from the power electronics system 20 and to the air in the anode air chamber 34 and the cathode air chamber 32 thereby providing benefits of removing heat from the power electronics system 20 and preheating the anode air stream and cathode air stream prior to providing the anode air flow stream and the cathode air flow streams to the fuel cell stack 12.

The balance of plant subsystem 14 is preferably mechanically isolated from the fuel cell stack 12 with resilient members 46. The anode air/fuel delivery system 28 may include a resilient tube-like member 48 extending between the anode blower 26 and the air/fuel handling plate 16. As perhaps best shown in FIG. 4, the anode blower 26 includes an interface housing 50 and a blower housing 52. During operation fuel is routed through the air/fuel handling plate 16, through the resilient member 48, through the air fuel mixing point, through the interface housing 50 and through the blower housing 52 and finally into the fuel cell stack 12. The blower housing 52 include a motor-powered impellers (not shown) to motivate the air and the fuel from the air/fuel handling plate 16 to the fuel cell stack 12.

FIG. 4 shows the fuel cell stack 12 in cross-section, and including a manifold member 54, a fuel feed tube 56, an onboard fuel reformer 30, fuel cell tubes 58, tube support members, an insulated body 62, and a recuperator 64. The manifold member 54 is provided to receive air and fuel from the anode air/fuel delivery system 28 and to deliver the air and fuel mixture to each of the fuel feed tubes 56. The manifold member 54 is connected to each of the fuel cell feed tubes 56 such that a substantially gas-tight seal is maintained between an inner chamber of each fuel feed tubes 56 and an inner chamber of the manifold member 54. In one embodiment, the manifold member 54 comprises a resilient member, for example, a flexible tube. The resilient member allows for movement of the plurality of fuel cell tubes 58 connected to the manifold member 54 relative to other fuel cell components. The resilient member can further dampen oscillations and reduce mechanical stresses on components of the fuel cell system due to movement of fuel cell components relative to each other. Movement of fuel cell components relative to each other can be caused by external forces on the fuel cell system (for example, vibrational movement), by thermal expansion mismatch between fuel cell system components and by fluid flow within the fuel cell system.

The fuel feed tubes 56 are disposed partially within the fuel cell tubes 58. The onboard fuel reformer 30 is positioned within each of the fuel cell tubes 58 proximate an electrochemically active region of the fuel cell tubes 58. Anode air and unreformed fuel is routed through the fuel feed tube 56 to the onboard fuel reformer 30 where the fuel is reformed and the resulting reformed fuel is heated during the exothermic reformation reactions (for an exemplary fuel cell system having an internal onboard fuel reformer, reference is made to U.S. Pat. No. 7,547,484, granted Jun. 16, 2009, the entire disclosure of which is hereby incorporated by reference and relied upon.) In alternate embodiments, the fuel can be reformed utilizing endothermic reactions and the fuel cell tubes can be heated to operating temperatures utilizing alternate heating devices such as an internal combustor or a resistance heating device.

The fuel cell tubes 58 each comprise an anode layer, an electrolyte layer, and a cathode layer at the active portion that generates electromotive force at the active portion at operating temperatures in the range of 700 to 850 degrees Celsius. However, only the active portion of the fuel cell tube 58 contains the anode layer, the electrolyte layer, and the cathode layer, and therefore, only a portion of each fuel cell tube 58 requires high operating temperatures for generating electromotive force.

The insulated body 62 comprises composite insulation material that can maintain the fuel cell stack 12 at the operating temperatures. The recuperator 64 transfers heat between the exhaust gases generated within the fuel cell stack 12 and the cathode air stream inlet to the fuel cell stack 12. In an alternate embodiment, heat exchangers can be utilized to transfer heat between other fluid streams.

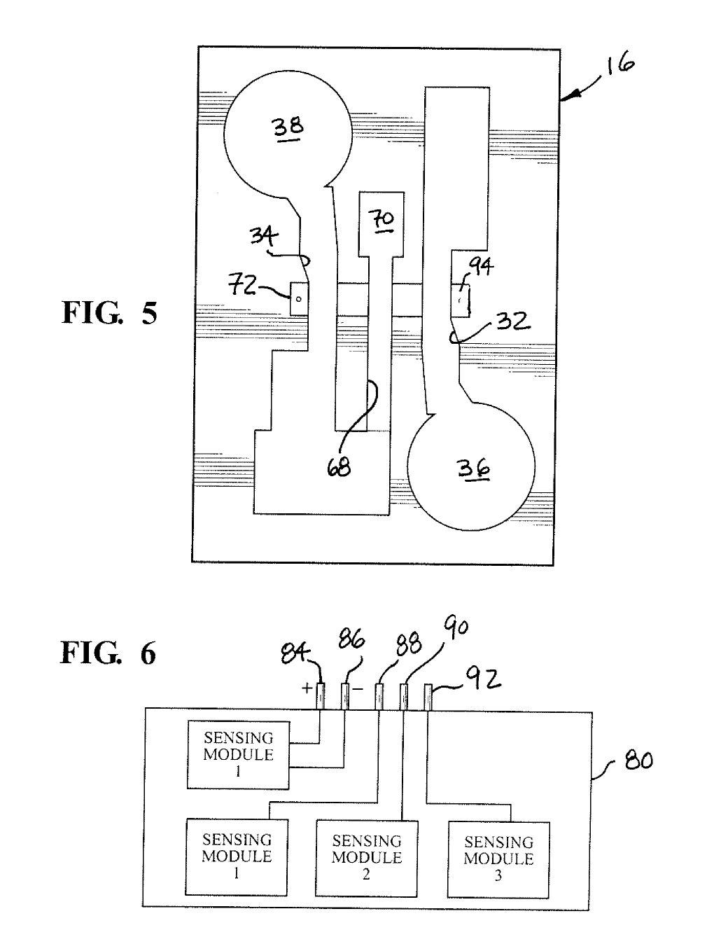

Referring now to FIGS. 5-8, a multi-stream flow sensor 66 is described in connection with a preferred embodiment of the fuel cell system 10. The air/fuel handling plate 16 includes a fuel flow path 68. A fuel pump 70 may be integrated into the air/fuel handling plate 16 at one end of the fuel flow path 68, or instead located near the plate 16 and fluidly connected to the fuel flow path 68. A sensor port 72 is established in the air/fuel handling plate as indicated by broken lines in FIG. 5. The sensor port 72 allows the one sensor 66 to be integrated into the air/fuel handling plate 16 and used to simultaneously sense flow rates or the anode air flow stream flowing through the anode air chamber 34, the fuel flow stream flowing through the fuel flow path 68, and the cathode air flow stream flowing through the cathode air chamber 32. The multi-stream flow sensor 66 can be attached to the air/fuel handling plate 16 through a snapping connection, pressure fits, screws, or by other suitable attachment methods.

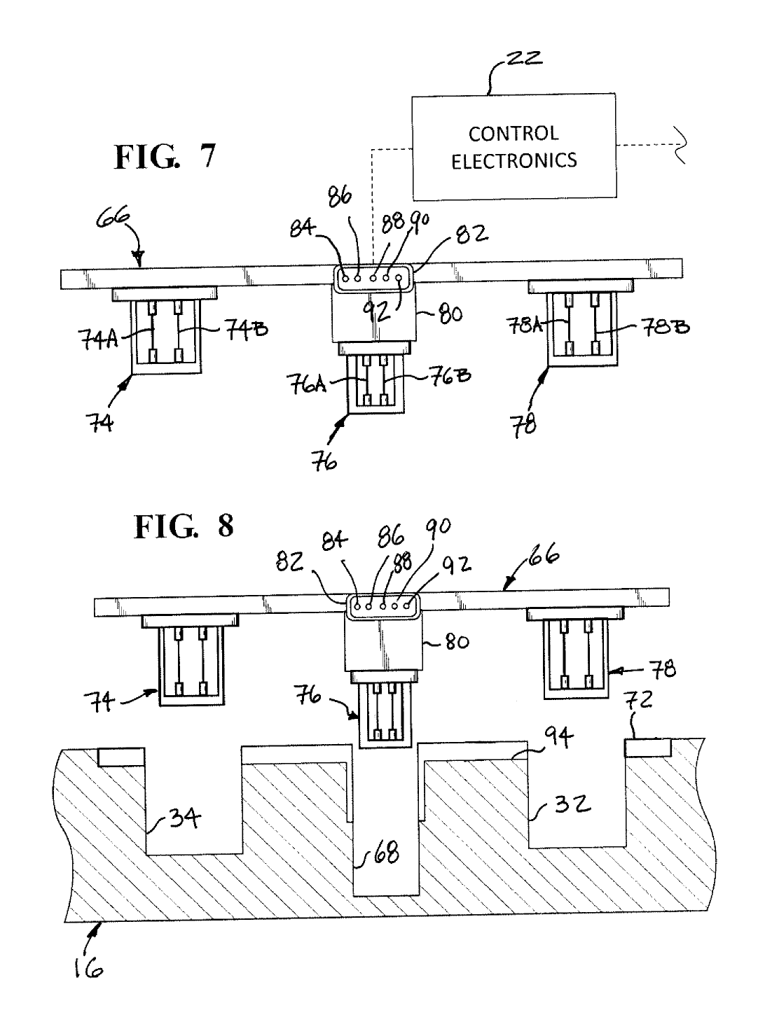

As perhaps best shown in FIG. 7, the multi-stream flow sensor 66 includes an anode air flow sensing unit 74, a flow fuel flow sensing unit 76, and a cathode air flow sensing unit 78. Each of the flow sensing units 74, 76, 78 are integrated in a single housing an operate utilizing a single circuit. The flow sensing units 74, 76, 78 each utilize a heated thin film anemometer flow sensing element paired with a reference element to sense flow rate. The thin-film membranes are indicated by the letter “A” and their corresponding reference elements indicated by the letter “B”. The membranes 74A, 76A, 78A may be of the type having a thin film temperature sensor printed on the upstream side, and one on the downstream side. A heater is integrated in the center of the membrane 74A, 76A, 78A which maintains a constant temperature. The thin electronic membranes 74A, 76A, 78A of each sensing unit 74-78 are placed in the respective gas flow streams. Without any airflow, the temperature profile across the membrane 74A, 76A, 78A is uniform. When air flows across the membrane 74A, 76A, 78A, the upstream side cools differently from the downstream side. The difference between the upstream and downstream temperature can be used to calculate the mass flow of the respective gas (air or fuel). Preferably, all of the sensing membranes 74A, 76A, 78A and their corresponding reference elements 74B, 76B, 78B are disposed parallel to one another and generally perpendicular to the planar construction of the air/fuel handling plate 16.

The multi-stream flow sensor 66 utilizes a single electric circuit board 80 (FIG. 6) and a single electrical connector port 82 (FIG. 7). An electrical connector (not shown) couples with the electrical connector port 82 and routes power and signals between the multi-stream flow sensor 66 and the fuel cell system 10 power and the control electronics 20. The single electric circuit board 80 includes two power terminals 84, 86. Terminal 84 corresponds with positive power (+) while terminal 86 corresponds with negative power (−). These terminal 84, 86 receive power at power module 4, which provides power to a plurality of sensing modules: Sensing Module 1, Sensing Module 2, and Sensing Module 3. The Sensing Modules 1, 2, and 3 operate the sensing elements of the respective sensing units 74, 76 and 78 to monitor flow rates. Therefore, Sensing Module 1 provides a signal indicative of anode air flow rate through the anode chamber 34, Sensing Module 2 provides a signal indicative of fuel flow rate through the fuel path 68, and Sensing Module 3 provides a signal indicative of the cathode air flow rate through the cathode air chamber 32. Terminals 88, 90, 92 in the electrical connector port 82 are associated with the respective anode air Sensing Module 1, fuel flow Sensing Module 2, and cathode air Sensing Module 3.

In the preferred embodiment, the anode air chamber 34, fuel flow path 68 and cathode air chamber 32 are arranged in the air/fuel handling plate 16 as side-by-side plenums. The anode and cathode air chambers 32, 34 are disposed in parallel toward the outer edges of the handling plate 16, with the fuel flow path 68 extending in parallel in the region between the air chambers 32, 34. The sensor port 72 bridges all three of these plenums 32, 34, 68 in a central, converging region of their respective paths, with the three flow sensing units 74, 76, 78 being linearly aligned with one another. When viewed from the top, as in FIG. 5, the air flow through the respective anode and cathode air chambers 32, 34 is in opposite directions. When viewed in cross-section, as in FIG. 8, the air chambers 32, 34 may be seen as having a shallower depth in the air/fuel handling plate 16 than that of the fuel flow path 68. In other words, the flow sensing unit 76 for the fuel gas may be located slightly below the respective air sensing units 74, 78. This arrangement may facilitate placement of the electric circuit board 80 and electrical connector port 82 generally above the fuel flow path 68, and between each of the cathode 32 and anode 34 air chambers. In fact, a small recess 94 may be formed in the air/fuel handling plate 16, between the air chambers 32, 34 to receive the circuit board 80 and connector 82 features of the sensor 66.

The multi-stream flow sensor 66 integrates multiple gas flow stream sensing into a unitary housing, utilizing a single circuit board 80, so that a single electrical connector port 82 and can be easily coupled within the fuel cell system 10. As a direct result, the robustness of the fuel cell assembly 10 is increased while manufacturing cost is decreased. In alternate designs, other flow sensor features may be incorporated, including, for example, various mechanical and electromagnetic flow sensors, temperature-based flow sensors, ultrasonic flow sensors, and coriolis flow sensors can be utilized to measure air and fuel flow rates. Further, exemplary housing components can include various plastic and metal components selected for manufacturability, end-use environment and cost.

The multi-stream flow sensor 66 works in concert with the control system 22 to determine a flow rate of air passing through the cathode air chamber 32 simultaneously with a flow rate of air passing through the anode air chamber 34 and a flow rate of fuel passing through the fuel path 68. Utilizing a single, multi-stream flow sensor 66 at a strategic location 72 in the air/fuel handling plate 16 provides significant cost reduction advantages compared to traditional systems utilizing several independent flow sensors each with separate mounting requires and electrical connection demands.

From the foregoing disclosure and detailed description of certain embodiments, it will be apparent that various modifications, additions and other alternative embodiments are possible without departing from the true scope and spirit of the invention. The embodiments discussed were chosen and described to provide illustrations of the principles of the invention and its practical application to thereby enable one of ordinary skill in the art to use the invention in various embodiments and with various modifications as are suited to the particular use contemplated. All such modifications and variations are within the scope of the invention as determined by the following claims when interpreted in accordance with the breadth to which they are fairly, legally, and equitably entitled.

What is claimed is:

1. A fuel cell system comprising:
a fuel cell stack configured to generate electricity by reacting oxygen and a gaseous fuel; said fuel cell stack including an anode portion and a cathode portion;
an air/fuel handling plate at least partially defining an anode air chamber, a cathode air chamber, and a fuel flow path; said anode air chamber configured to route air to said anode portion of said fuel cell stack; said cathode air chamber configured to route air to said cathode portion of said fuel cell stack; and said fuel flow path configured to route gaseous fuel to said anode portion of said fuel cell; and
a unitary, multi-stream flow sensor coupled to said air/fuel handling plate; said multi-stream flow sensor having an anode air flow sensing unit operatively disposed in said anode air chamber, a fuel flow sensing unit operatively disposed in said fuel flow path, and a cathode air flow sensing unit operatively disposed in said cathode air chamber.

2. The fuel cell system of claim 1, wherein said air/fuel handling plate includes a converging region defined by said anode air chamber, said cathode air chamber, and said fuel flow path being arranged in generally parallel, side-by-side relationship; said multi-stream flow sensor disposed in said converging region.

3. The fuel cell system of claim 1, wherein at least one of said anode air flow sensing unit, said fuel flow sensing unit, and said cathode air flow sensing unit include a heated thin film anemometer sensing membrane.

4. The fuel cell system of claim 3, wherein said anode air flow sensing unit, said fuel flow sensing unit, and said cathode air flow sensing unit each include a heated thin film anemometer sensing membrane.

5. The fuel cell system of claim 4, wherein said anode air flow sensing unit, said fuel flow sensing unit, and said cathode air flow sensing unit each include a reference element paired with said respective sensing membranes.

6. The fuel cell system of claim 5, wherein said sensing membranes for each of said anode air flow sensing unit, said fuel flow sensing unit, and said cathode air flow sensing unit are disposed parallel to one another

7. The fuel cell system of claim 5, wherein each said sensing membrane for each of said anode air flow sensing unit, said fuel flow sensing unit, and said cathode air flow sensing unit is disposed parallel to said respective paired reference element.

8. The fuel cell system of claim 5, wherein each of said sensing membranes and each of said reference elements for each of said anode air flow sensing unit, said fuel flow sensing unit, and said cathode air flow sensing unit are disposed parallel to one another.

9. The fuel cell system of claim 8, wherein said sensing membranes and said reference elements are disposed generally perpendicular to said air/fuel handling plate.

10. The fuel cell system of claim 3, wherein said anode air flow sensing unit, said fuel flow sensing unit, and said cathode air flow sensing unit are generally linearly aligned with one another.

11. The fuel cell system of claim 3, wherein said fuel flow sensing unit is disposed below said anode air flow sensing unit and said cathode air flow sensing unit.

12. The fuel cell system of claim 3, wherein said multi-stream flow sensor includes an electric circuit board and an electrical connector port disposed generally above said fuel flow sensing unit.

13. The fuel cell system of claim 12, wherein said air/fuel handling plate includes a recess intersecting said fuel flow path and between said anode and cathode air chambers for receiving said circuit board and said connector port of said multi-stream flow sensor.

14. The fuel cell system of claim 1, further including a control system signally communicating with said multi-stream flow sensor.

15. An air/fuel handling plate for a fuel cell system comprising:
an anode air chamber, a cathode air chamber, and a fuel flow path; said anode air chamber configured to route air to said anode portion of a fuel cell stack; said cathode air chamber configured to route air to said cathode portion of a fuel cell stack; and said fuel flow path configured to route gaseous fuel to the anode portion of a fuel cell; and
a unitary, multi-stream flow sensor coupled to said air/fuel handling plate; said multi-stream flow sensor having at least two sensing units operatively disposed in respective ones of said anode air chamber, said fuel flow path, and said cathode air chamber.

16. The fuel cell system of claim 15, wherein said air/fuel handling plate includes a converging region defined by said anode air chamber, said cathode air chamber, and said fuel flow path being arranged in generally parallel, side-by-side relationship; said multi-stream flow sensor disposed in said converging region.

17. The fuel cell system of claim 15, wherein said at least two sensing units each include a heated thin film anemometer sensing membrane and a paired reference element.

18. The fuel cell system of claim 15, wherein said multi-stream flow sensor includes an electric circuit board and an electrical connector port; said air/fuel handling plate includes a recess for receiving said circuit board and said connector port.

19. A method for routing a air and fuel gases to a solid oxide fuel cell system, said method comprising the steps of:
providing a fuel cell stack configured to generate electricity by reacting oxygen and a gaseous fuel, the fuel cell having an anode portion and a cathode portion;
routing air to the anode portion of the fuel cell stack through an anode air chamber; routing air to the cathode portion of the fuel cell stack through a cathode air chamber; routing gaseous fuel to the anode portion of the fuel cell stack through a fuel flow path;
said routing step including converging the respective flows of cathode air, anode air and fuel in generally parallel, side-by-side flow paths; and
simultaneously sensing the mass flow rates of the air and fuel in each of the anode air chamber, cathode air chamber and fuel flow path with a multi-stream flow sensor disposed in the converging region.

20. The method of claim 19, wherein said step of simultaneously sensing includes heating a thin-film membrane, passing mass fluid flow over the membrane and measuring a temperature difference in the membrane.
